(19) United States
(12) Patent Application Publication
(10) Pub. No.: US 2011/0216439 A1
(43) Pub. Date: Sep. 8, 2011

(54) HEAD PARKING RAMP AND HARD DISK DRIVE HAVING THE SAME

(75) Inventors: Ji Hoon KANG, Suwon-si (KR); Sung Joong YUN, Suwon-si (KR)

(73) Assignee: Samsung Electronics Co., Ltd, Suwon-si (KR)

(21) Appl. No.: 13/038,677

(22) Filed: Mar. 2, 2011

(30) Foreign Application Priority Data
Mar. 2, 2010 (KR) 2010-0018431

(51) Int. Cl. G11B 5/48; G11B 21/02

(52) U.S. Cl. 360/75; 360/244; G9B/21.003; G9B/5.147

(57) ABSTRACT

A hard disk drive includes a head stack assembly having a read/write head to read data stored on a disk and/or to write data to the disk while flying over the disk. The read/write head includes an end tap that is disposed at a peripheral portion of the read/write head. A head parking ramp is arranged close to the disk and may support the read/write head while in the park position such that the end tap contacts the head parking ramp and is supported thereon. A heater is provided in the head parking ramp to heat the read/write head.

### CROSS-REFERENCE TO RELATED APPLICATIONS

This application claims priority under 35 U.S.C. §119(a) from Korean Patent Application No. 10-2010-0018431, filed on Mar. 2, 2010, in the Korean Intellectual Property Office, the disclosure of which is incorporated herein in its entirety by reference.

### BACKGROUND

1. Field of the Invention

The present general inventive concept relates to a head parking ramp and a hard disk drive (HDD) having the head parking ramp, and more particularly, to a head parking ramp which facilitates washing of a disk lube and reduces a change in flying height (FH) of a read/write head with respect to a disk and a change in a dynamic characteristic of a suspension, during an initial loading of the read/write head on the disk, so that deterioration of read/write performance of the read/write head may be prevented, and an HDD having the head parking ramp.

2. Description of the Related Art

A read/write head may be parked in a parking area provided in a central area of a disk or on a separate support structure, that is, a ramp. In an HDD in which a read/write head is parked on a ramp, the temperatures of the read/write head and a suspension decrease to the same temperature of the room temperature while the read/write head and the suspension are parked on the ramp.

In this state, when the HDD starts to operate in response to an operation command, the read/write head and the suspension are loaded on a disk and the temperatures of the read/write head and the suspension gradually increase by from 3° C. to 10° C. higher than the room temperature within a few seconds to a few minutes. That is, the temperature of the read/write head is locally increased at fast speed due to a frictional force generated against a disk after being loaded on the disk. A difference in temperature may cause a change in the FH of a read/write head with respect to a disk during the initial driving of an HDD and deterioration of read/write performance.

FIG. 1 is a graph showing a change in the FH of a read/write head according to a time measured after being loaded on the disk. Referring to FIG. 1, it can be seen that the FH of a read/write head gradually decreases from about 1.2 nm due to a temperature difference during the initial driving of an HDD of about 30 seconds. The generation of a frictional force between a disk and a read/write head and the increase in the temperature of a read/write head during the initial driving of an HDD may generate the following initial performance deterioration problems.

First, a disk lube is provided on a slider of a read/write head. The lube initially exists in a high viscosity liquid state. When a read/write head is loaded on a disk and temperature increases due to a frictional force between the read/write head and the disk, the viscosity of the lube is lowered and the lube is washed out. During the initial loading of a read/write head on the disk, the existence of lube increases a gap between the read/write head and the disk until the disk lube is washed out.

Second, recently, in order to decrease the gap between a read/write head and a disk, a so-called flying on demand (FOD) technology to protrude only a read/write head portion by locally heating the read/write head portion has been applied to most HDDs. An amount of protrusion of a read/write head may sensitively vary according to the temperature of the read/write head. During the initial loading of a read/write head on a disk at a relatively low temperature like a room temperature, the amount of protrusion decreases so that a gap between the read/write head and the disk relatively increases. Accordingly, read/write performance may be deteriorated.

Third, a write field during writing is deteriorated due to a low temperature during the initial loading of a read/write head on a disk so that read/write performance may be deteriorated.

Fourth, a low temperature during the initial loading of a read/write head on a disk may generate a change in a dynamic characteristic of a suspension. Thus, the FH of a read/write head may be affected by the suspension until the temperature of the read/write head rises sufficiently.

### SUMMARY

The general inventive concept provides a head parking ramp which facilitates washing of a disk lube and reduces a change in flying height (FH) of a read/write head with respect to a disk and a change in a dynamic characteristic of a suspension, during the initial loading of the read/write head on a disk, so that deterioration of read/write performance of the read/write head may be prevented, and an HDD having the head parking ramp.

According to feature of the general inventive concept, there is provided a hard disk drive including a head stack assembly comprising a read/write head to read data stored on a disk or writing data to the disk while flying over the disk, and an end tap provided at a peripheral portion of the read/write head, a head parking ramp arranged close to the disk and on which the read/write head is parked with the end tap being in contact with and supported on the head parking ramp, and a heater provided in the head parking ramp and to heat an area of the read/write head.

The hard disk drive may further include a heater driver to switch the heater on or off, and a controller to control an operation of the heater driver.

The controller may control an operation of the heater driver to heat the area of the read/write head by switching the heater on in advance before an operation signal is input to the head stack assembly to load the read/write head on the disk.

The head parking ramp may include a ramp body and a parking guide rail provided on the ramp body and forming a parking guide surface on which the end tap is supported by being in contact therewith.

The heater may be provided in the ramp body at a position close to the read/write head when the end tap is parked at a parking position on the parking guide surface by being in contact with and supported on the parking guide surface.

The heater may be provided in an overall area of the ramp body.

The head stack assembly may further include a slider on which the read/write head is mounted, a suspension supporting the slider to be elastically biased against a surface of the disk, and a flexure supported on the suspension and to which the slider is coupled, wherein the head parking ramp may further include a third limiter to prevent the flexure from being outwardly deviated from the ramp body, and the heater is provided in the third limiter.

According to another feature of the general inventive concept, there is provided a head parking ramp to guide parking of a read/write head with an end tap being in contact with and supported on the head parking ramp, the head parking ramp including a ramp body, a parking guide rail provided on the ramp body and forming a parking guide surface on which the end tap is supported by being in contact therewith, and a heater provided in the head parking ramp at a position close to the read/write head and to heat an area of the read/write head when the end tap is parked at a parking position on the parking guide surface by being in contact with and supported on the parking guide surface.

The heater may be provided in an overall area of the ramp body.

The head parking ramp may further include a third limiter to prevent a flexure to which a slider with the read/write head mounted thereon is coupled from being outwardly deviated from the ramp body, wherein the heater is provided in the third limiter.

### BRIEF DESCRIPTION OF THE DRAWINGS

Exemplary embodiments of the general inventive concept will be more clearly understood from the following detailed description taken in conjunction with the accompanying drawings in which:

FIG. 1 is a graph showing a change in the flying height (FH) of a read/write head according to a time measured after the read/write head is loaded on a disk;

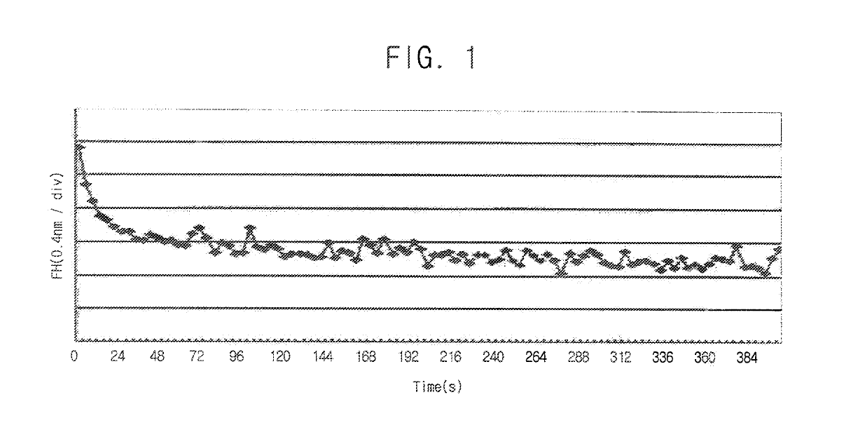

FIG. 2 is a perspective view of an HDD according to an exemplary embodiment of the present general inventive concept;

FIG. 3 is a perspective view showing a process of parking an end tap on a ramp during parking of a read/write head;

FIG. 4 schematically illustrates a state in which an end tap is parked on a parking guide surface;

FIG. 5 is a perspective view of a ramp according to an exemplary embodiment of the present general inventive concept;

FIG. 6 is a control block diagram of an HDD according to an exemplary embodiment of the present general inventive concept; and

FIG. 7 is a flowchart illustrating an exemplary method of loading a read/write head on a disk, according to the present general inventive concept.

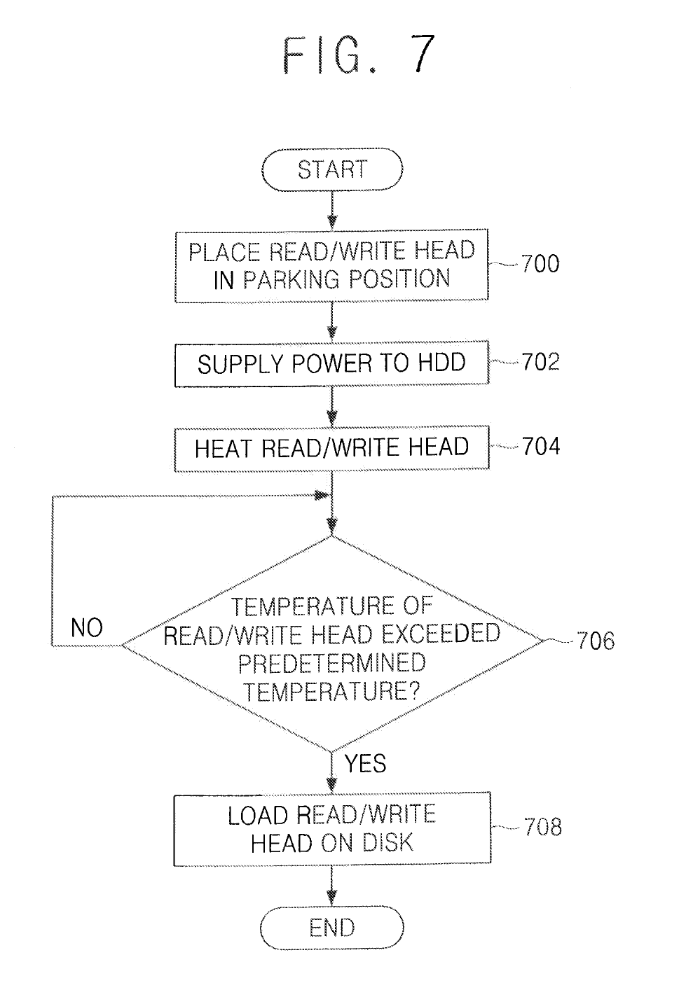

### DETAILED DESCRIPTION OF THE EMBODIMENTS

The attached drawings to illustrate embodiments of the general inventive concept are referred to in order to gain a sufficient understanding of the general inventive concept and the merits thereof. Hereinafter, the general inventive concept will be described in detail by explaining embodiments of the general inventive concept with reference to the attached drawings. Like reference numerals in the drawings denote like elements.

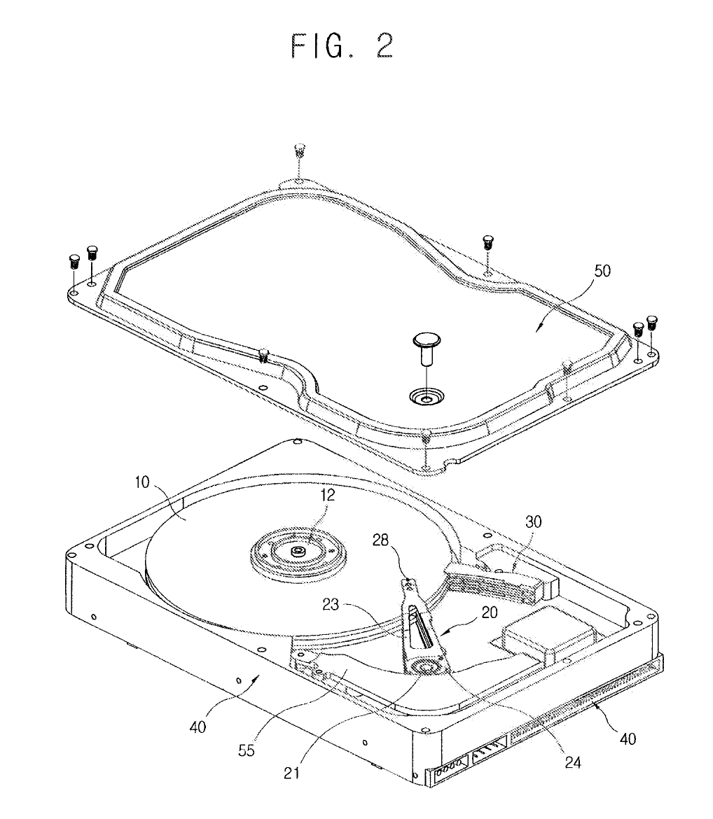

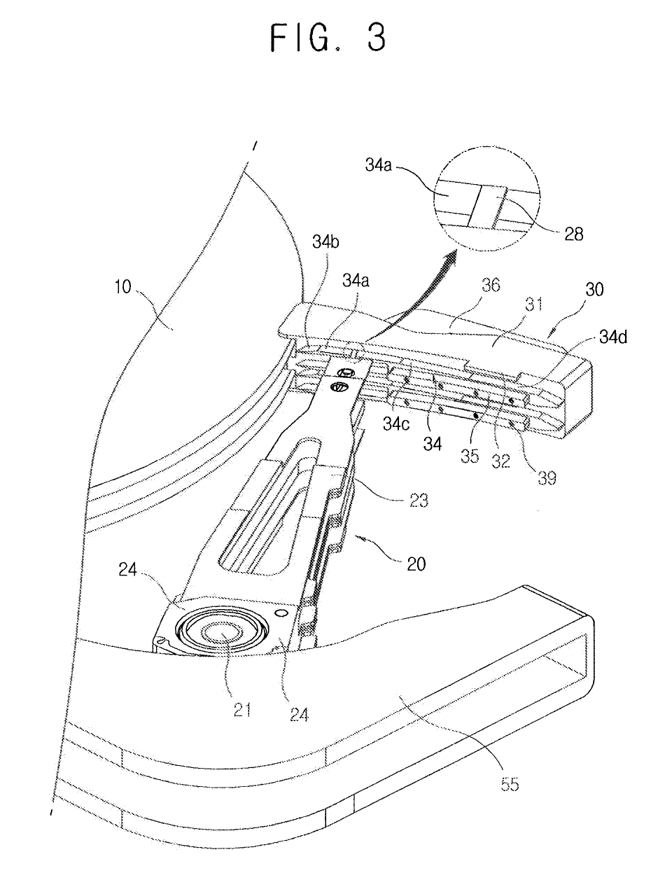

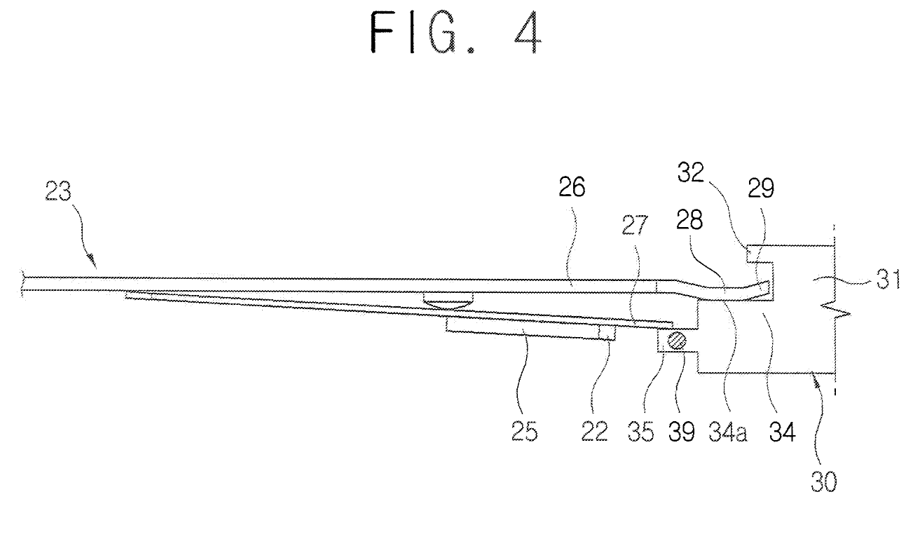

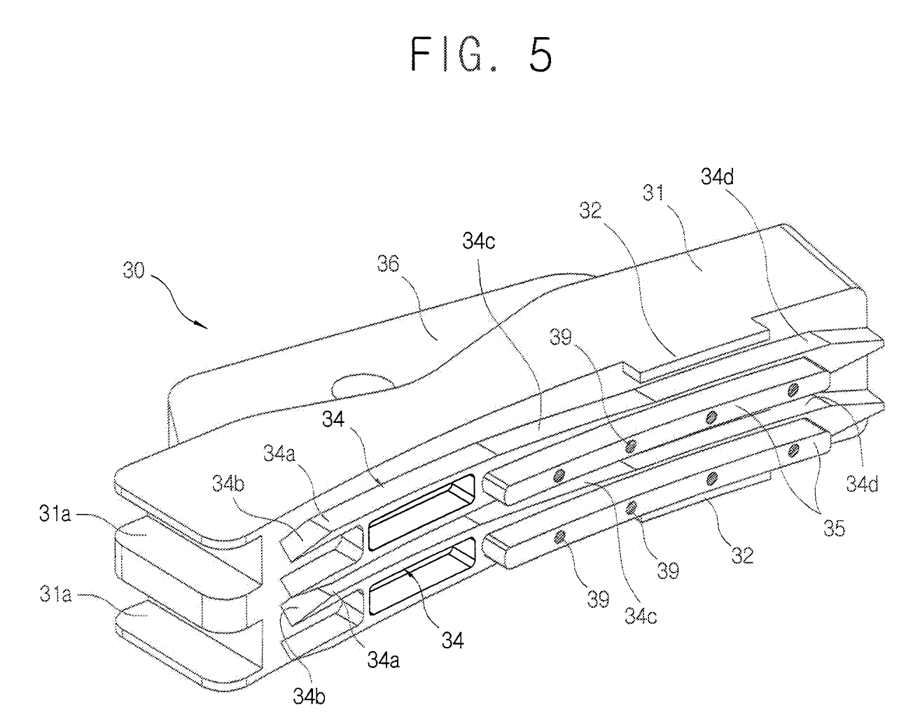

FIG. 2 is a perspective view of an HDD 1 according to an exemplary embodiment of the present general inventive concept. FIG. 3 is a perspective view showing a process of parking an end tap on a ramp during parking of a read/write head. FIG. 4 schematically illustrates a state in which an end tap is parked on a parking guide surface. FIG. 5 is a perspective view of a ramp according to an exemplary embodiment of the present general inventive concept.

Referring to FIGS. 2-5, the HDD 1 according to the present exemplary embodiment may comprise an outer housing, and includes a disk 10 to record and store data, a spindle motor 12 to rotate the disk 10, a head stack assembly (HSA) 20 to read out data on the disk 10 while moving across the disk 10 around a pivot shaft 21 as a rotation center, and a head parking ramp 30 having an area corresponding to a read/write head 22 (refer to FIG. 8) in which the read/write head 22 is parked when the disk 10 stops rotating and having a heater 39 to heat the area corresponding to the read/write head 22 in advance. Generally, the heat may be included in the housing

Also, the HDD 1 according to the present exemplary embodiment may further include a printed circuit board assembly (PCBA) 40 to control the above-described constituent elements by using most circuit parts mounted on a printed circuit board (PCB), a base 50 on which the constituent elements are assembled, and a cover 50 to cover an upper portion of the base 50.

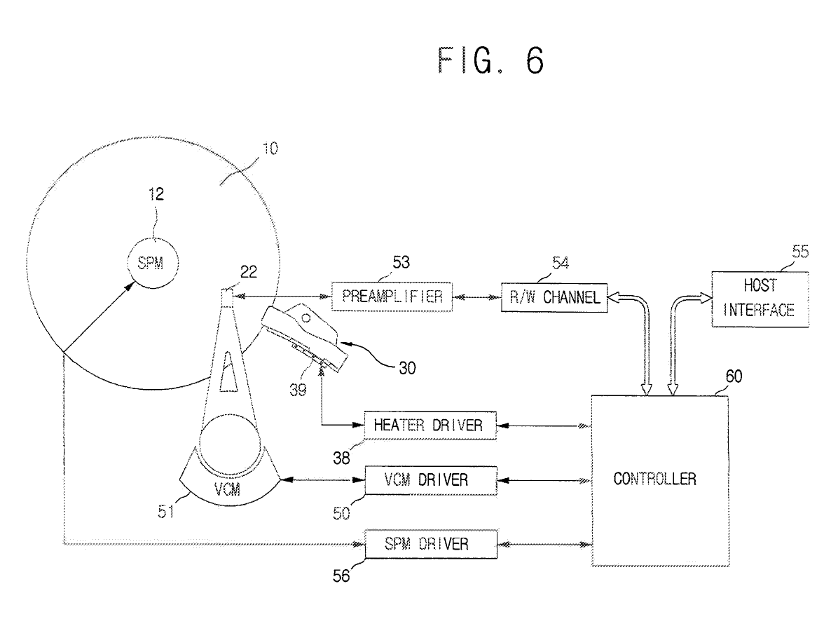

The HSA 20 is a carriage to record data on the disk 10 and/or read out data recorded on the disk 10. The HSA 20 may include a read/write head 22 to write and/or read data with respect to the disk 10, an actuator arm 23 pivoting around the pivot shaft 21 over the disk 10 to allow the read/write head 22 to access data on the disk 10, and a pivot shaft holder 24 to rotatably support the pivot shaft 21, to which the actuator arm 23 is coupled by being supported thereon. A bobbin (not shown) with a voice coil motor (VCM) coil wound therearound is located between magnets of a VCM 51 (refer to FIG. 6) in the opposite direction to the actuator arm 23.

The VCM 51 is a sort of a drive motor to pivot the actuator arm 23 and move the read/write head 22 to a desired position on the disk 10. The VCM 51 is operated according to the Fleming's left hand rule, that is, a force is generated when current flows in a conductive body existing in a magnetic field. As current is applied to a VCM coil located between the magnets, a force is applied to the bobbin so as to pivot the bobbin. Accordingly, the actuator arm 23 extending from the pivot shaft holder 24 in the opposite direction to the bobbin pivots. Then, the read/write head 22 supported at an end portion of the actuator arm 23 moves in a radial direction of the disk 10 that is rotating, to thereby search a track and access information. The accessed information is signal processed.

A suspension 26 is provided at one end portion of the actuator arm 23 as illustrated in FIG. 4. The suspension 26 supports a slider 25 having the read/write head 22 mounted thereon to be elastically biased against a surface of the disk 10. The slider 25 is supported on the suspension 26 by being attached to a flexure 27 that is formed of a flexible material. An end tap 28 extending from an end portion of the suspension 26 and to park the read/write head 22 by being substantially supported on the head parking ramp 30 is installed on the end portion of the suspension 26.

In the present exemplary embodiment, the end tap 28 is of a canoe type, but the right scope of the present general inventive concept is not limited thereto. That is, the end tap 28 may have any shape such as a rod shape, not a boat shape, or a particular contact surface, only if it can be supported on the head parking ramp 30 by contacting the same.

In a process of reading out data by the read/write head 22 arranged over the disk 10 as illustrated in FIG. 2, when power is cut off and the disk 10 stops rotating, the read/write head 22 is moved to the head parking ramp 30 and parked thereon as the end tap 28 contacts the head parking ramp 30 as illustrated in FIGS. 3 and 4. That is, when power is off and the disk 10 stops rotating, the VCM 51 rotates the actuator arm 23 clockwise. Accordingly, the end tap 28 contacts a parking area 34d of the head parking ramp 30, that is, a parking position of a parking guide rail 34 of the head parking ramp 30, and is guided to be accommodated on the head parking ramp 30.

In the state of FIG. 3, that is the read/write head 22 is parked on the head parking ramp 30, when the actuator arm 23 is freely moved by external shock or vibrations applied to the HDD 1, the read/write head 22 may be disengaged from the head parking ramp 30 and moved toward a recording surface of the disk 10.

Consequently, the read/write head 22 may contact the recording surface of the disk 10, thereby possibly damaging the read/write head 22 and the recording surface of the disk 10. Accordingly, when the rotation of the disk 10 is stopped so that the read/write head 22 is parked on the head parking ramp 30, the actuator arm 23 should be locked at a particular position so as not to be freely rotated. To this end, an actuator latch (not shown) is provided. The actuator latch may be installed in a housing 55 partially encompassing and supporting the HSA 20 of FIG. 2.

As illustrated in FIGS. 4 and 5, the head parking ramp 30 may include a ramp body 31 where a heater 39 is installed, a fixed portion 36 provided on the rear surface of the ramp body 31, an end tap limiter 32 provided on the front surface of the ramp body 31, a third limiter 35, and a parking guide rail 34.

The front surface of the ramp body 31 where the end tap limiter 32, the third limiter 35, and the parking guide rail 34 are formed has a curved shape corresponding to a direction in which the end tap 28 moves (refer to FIG. 3). A disk groove 31a where a part of an outer circumferential surface of the disk 10 is located is formed at a side of the ramp body 31. In the present exemplary embodiment, two disks 10 are arranged so that two disk grooves 31a are formed in the ramp body 31.

While the end tap limiter 32, the third limiter 35, and the parking guide rail 34 protrude from the front surface of the ramp body 31, the fixed portion 36 is provided on the rear surface of the ramp body 31. The fixed portion 36 fixes the head parking ramp 30 on the base 50 (refer to FIG. 2). The end tap limiter 32, the third limiter 35, and the parking guide rail 34 may be, for example, injection-molded using a plastic material to be integrally with the ramp body 31 and the fixed portion 36. These elements are described as follows.

The end tap limiter 32 prevents the end tap 28 from being outwardly deviated from the head parking ramp 30 which may occur due to external shock when the read/write head 22 is parked on the head parking ramp 30. The third limiter 35 is provided on the ramp body 31 to relatively further protrude from a surface of the parking guide rail 34 in the direction in which the end tap limiter 32 protrudes. The third limiter 35 prevents the flexure 27 (refer to FIG. 4) from being vertically and/or outwardly deviated from the head parking ramp 30.

That is, in a state in which the read/write head 22 is parked, when external shock is occurs and the end tap 28 bounces in the opposite direction to the third limiter 35, the end tap 28 collides against the end tap limiter 32. Then, the suspension 26 is deformed in the opposite direction to the end tap limiter 32 due to the external shock, the flexure 27 collides against the third limiter 35 so that the movement may be restricted. Accordingly, shock to the end tap limiter 32 caused by an external impact may be absorbed by the suspension 26, which may be made of elastic, as mentioned above.

The parking guide rail 34 is a portion that the end tap 28 substantially contacts supports thereon to park the read/write head 22. A parking guide surface 34a on which the end tap 28 located over the disk 10 as in FIG. 2 is parked by being in contact therewith and guided as in FIGS. 3 and 4 when the rotation of the disk 10 is stopped.

The parking guide surface 34a may be a horizontal surface, or inclined upwardly at a portion close to the disk 10 and then slightly horizontally, for smooth guiding of the end tap 28. As a result, as the end tap 28 is supported in an area of the end tap limiter 32 of a central area of the parking guide surface 34a, the read/write head 22 is park.

As described above, while the room temperature is maintained as the read/write head 22 is parked on the head parking ramp 30, the temperature of read/write head 22 rises due to a frictional force of the disk 10 when the read/write head 22 is loaded on the disk 10. The above temperature difference may cause a change in the FH of the read/write head 22 with respect to the disk 10 and deterioration in the read/write performance of the read/write head 22 during the initial driving of an HDD 1.

In other words, while the temperature of the read/write head 22 is maintained when parked on the head parking ramp 30, the temperature of read/write head 22 increases, however, during the initial loading of the read/write head on the disk 10 and the temperature difference changes the FH of the read/write head 22 with respect to the disk 10 and the dynamic characteristic of the suspension 26 so that the read/write performance of the read/write head 22 may be deteriorated.

To address the above issue, at least one exemplary embodiment includes a heater 39 provided in the head parking ramp 30 so as to heat the area of the read/write head 22 in advance before the initial driving of the read/write head 22 with respect to the disk 10. The heater 39 may be disposed in the ramp body 31 at a position adjacent to the read/write head 22 when the end tap 28 is parked at a parking position on the parking guide surface 34a by being in contact therewith and supported thereon. That is, the heater 39 may be provided at a local position of the ramp body 31.

However, in some cases, the heater 39 may be provided in the overall area of the ramp body 31. Accordingly, when the heater 39 is provided in the overall area of the ramp body 31, not only the read/write head 22 but also neighboring structures may be quickly heated.

The former case, that is, where the heater 39 is provided at a local position of the ramp body 31, may be advantageous in terms of costs and efficiency. Additionally, at least one exemplary embodiment may include the heater 39 in an area of the third limiter 35 in the ramp body 31, as illustrated in FIG. 4.

When the heater 39 is provided in the area of the third limiter 35, as illustrated in FIG. 4, the heater 39 may be disposed close to the read/write head 22 while the end tap 28 is parked at a parking position on the parking guide surface 34a by being in contact therewith and supported thereon, so that it may be easy to heat the area of the read/write head 22. However, the heater 39 is not necessarily provided in the area of the third limiter 35. The heater 39 may be provided in an area of the parking guide rail 34 or end tap limiter 32 only if the area of the read/write head 22 can be heated in advance.

In at least one exemplary embodiment, the heater 39 may be disposed in the parking ramp 30 or coupled to a predetermined position of the parking ramp 30. For example, the heater 39 is preferably injection-molded to be integrally inserted during the manufacturing of the head parking ramp 30. The heater 39 is connected to a heater driving unit 38 to switch the heater 39 on or off. The heater driving unit 38 is controlled by a controller 60, which will be described below with reference to FIG. 6.

FIG. 6 is a control block diagram of an HDD 1 according to an exemplary embodiment of the present general inventive concept. Referring to FIG. 6, the HDD 1 according to the present exemplary embodiment may include a preamplifier 53, a read/write (R/W) channel 54, a host interface 55, a VCM driver 50, an SPM driver 56, a heater driver 38, and a controller 60 to control the constituent elements.

The preamplifier 53 amplifies a data signal that the read/write head 22 reproduces from the disk 10 and/or amplifies write current converted by the R/W channel 54, and records an amplified signal on the disk 10 by using the read/write head 22. The R/W channel 54 converts a signal amplified by the preamplifier 53 to a digital signal and transmits the digital signal to a host device (not shown) via the host interface 55. The preamplifier 53 may also receive data input by a user via the host interface 55, converts a received data to a binary data stream that is easy to record, and inputs the binary data stream to the preamplifier 53.

The host interface 55 transmits the data converted to a digital signal to the host device, and/or receives user input data from the host device and inputs the user input data to the R/W channel 54 under the control of the controller 60.

The VCM driver 50 receives a control signal of the controller 60 and adjusts the amount of current applied to the VCM 51. The SPM driver 56 receives a control signal of the controller 60 and adjusts the amount of current applied to the spindle motor 12. The heater driver 38 switches on/off the heater 39 provided in the area of the third limiter 35.

The controller 60 provided in the HDD 1 according to at least one exemplary embodiment controls the operation of the heater driver 38. For example, the controller 60 controls the operation of the heater driver 33 to heat the area of the read/write head 22 by switching the heater 39 on in advance before an operation signal is input to the HSA 20 to load the read/write head 22 on the disk 10. Here, the controller 60 may control the amount of current applied to the heater 39 through the heater driver 38 to be a predetermined value.

For example, by varying the amount of current applied to the heater 39, a relation of the FH or read/write performance of the read/write head 22 with respect to the disk 10 during the initial driving is determined in advance and stored as a table. The controller 60 may determine the amount of current applied to the heater 39 based on the relation of the table. The table may be stored in a memory.

Accordingly, in at least one exemplary embodiment, when the power of the HDD 1 is switched off and thus the rotation of the disk 10 is stopped, the VCM 51 rotates the actuator arm 23 clockwise around the pivot shaft 21 as a rotation center. The read/write head 22 and the end tap 28 located over the disk 10 are rotated clockwise as in FIG. 3. The end tap 28 moves to a parking position along the parking guide surface 34a of the parking guide rail 34 where the end tap 28 is eventually parked.

While the read/write head 22 is parked, when the power of the HDD 1 is switched on, the disk 10 rotates, and an operation signal is simultaneously input to the HSA 20 so that the read/write head 22 is loaded on the disk 10. Before the read/write head 22 is loaded on the disk 10, the controller 60 switches on the heater 38 through the heater driver 38 and controls a predetermined amount of current to be supplied to the heater 39. Then, the area of the read/write head 22 may be heated to a desired target temperature in advance before the read/write head 22 is loaded on the disk 10. As a result, a pre-heated read/write head 22 may be loaded on the disk 10.

When the pre-heated read/write head 22 is loaded on the disk 10 in an already heated state, lube that may exist on the disk 10 may be quickly washed away so that a gap between the read/write head 22 and the disk 10 may be increased. Accordingly, the deterioration of read/write performance of the read/write head 22 may be prevented. In addition, a change in the FH of the read/write head 22 with respect to the disk 10 and a change in a dynamic characteristic of the suspension 26 may be reduced so that the deterioration of read/write performance of the read/write head 22 may be prevented.

As described above, according to the present general inventive concept, during the initial loading of a read/write head 22 on a disk 10, a disk lube may be easily and quickly removed, and a change in the FH of a read/write head 22 with respect to a disk and a change in a dynamic characteristic of a suspension 26 may be reduced so that the deterioration of read/write performance of the read/write head 22 may be prevented.

While the general inventive concept has been particularly shown and described with reference to exemplary embodiments thereof, it will be understood that various changes in form and details may be made therein without departing from the spirit and scope of the following claims.

What is claimed is:

1. A hard disk drive comprising:
a head stack assembly including a read/write head to at least one of read data stored on a disk and write data to the disk while flying over the disk and including an end tap disposed at a peripheral portion of the read/write head;
a head parking ramp arranged close to the disk and on which the read/write head is parked with the end tap being in contact with and supported on the head parking ramp; and
a heater disposed in the head parking ramp and to heat an area of the read/write head.

2. The hard disk drive of claim 1, further comprising:
a heater driver to switch the heater on or off; and
a controller to control an operation of the heater driver.

3. The hard disk drive of claim 2, wherein the controller controls an operation of the heater driver to heat the area of the read/write head by switching the heater on in advance before an operation signal is input to the head stack assembly to load the read/write head on the disk.

4. The hard disk drive of claim 1, wherein the head parking ramp comprises:
a ramp body; and
a parking guide rail provided on the ramp body and forming a parking guide surface on which the end tap is supported by being in contact therewith.

5. The hard disk drive of claim 4, wherein the heater is provided in the ramp body at a position close to the read/write head when the end tap is parked at a parking position on the parking guide surface by being in contact with and supported on the parking guide surface.

6. The hard disk drive of claim 4, wherein the heater is provided in an overall area of the ramp body.

7. The hard disk drive of claim 1, wherein the head stack assembly further comprises:
a slider on which the read/write head is mounted;
a suspension supporting the slider to be elastically biased against a surface of the disk; and
a flexure supported on the suspension and to which the slider is coupled,
wherein the head parking ramp further comprises a third limiter to prevent the flexure from being outwardly deviated from the ramp body, and the heater is provided in the third limiter.

8. A head parking ramp to guide parking of a read/write head with an end tap being in contact with and supported on the head parking ramp, the head parking ramp comprising:
a ramp body;
a parking guide rail disposed on the ramp body and forming a parking guide surface on which the end tap is supported by being in contact therewith; and
a heater provided in the head parking ramp at a position close to the read/write head and to heat an area of the read/write head when the end tap is parked at a parking position on the parking guide surface by being in contact with and supported on the parking guide surface.

9. The head parking ramp of claim 8, wherein the heater is provided in an area of the ramp body.

10. The head parking ramp of claim 8, further comprising a third limiter to prevent a flexure to which a slider with the read/write head mounted thereon is coupled from being outwardly deviated from the ramp body,
wherein the heater is provided in the third limiter.
